(19) United States
(12) Patent Application Publication
(10) Pub. No.: US 2020/0109779 A1
(43) Pub. Date: Apr. 9, 2020

(54) SYSTEM AND METHOD FOR CONTROLLING FLOW OF TRANSMISSION FLUID

(71) Applicant: GM GLOBAL TECHNOLOGY OPERATIONS LLC, Detroit, MI (US)

(72) Inventors: Dongxu Li, Troy, MI (US); Chunhao J. Lee, Troy, MI (US); Derek F. Lahr, Howell, MI (US); Dmitriy Bruder, Auburn Hills, MI (US); Neeraj S. Shidore, Novi, MI (US); Norman K. Bucknor, Troy, MI (US); Farzad Samie, Franklin, MI (US)

(21) Appl. No.: 16/154,266

(22) Filed: Oct. 8, 2018

(51) Int. Cl. F16H 61/02

(52) U.S. Cl. CPC F16H 61/0206; B60W 10/11

(57) ABSTRACT

A system for controlling flow of transmission fluid in a vehicle may include a first pump, a second pump, a first check valve, a second check valve, and a fluid line. The first pump may include a first intake in fluid communication with a transmission discharge and a first discharge in fluid communication with a transmission intake. The second pump may include a second intake and a second discharge. The first check valve may include a first input in fluid communication with the second discharge and a first output in fluid communication with the transmission intake. The second check valve may include a second input in fluid communication with the transmission discharge and a second output in fluid communication with the second intake. The fluid line may include a first end in fluid communication with the second discharge and a second end in fluid communication with the second input.

### INTRODUCTION

The subject disclosure relates to a system and method for controlling flow of transmission fluid in a vehicle.

A traditional fuel engine vehicle may include a mechanical pump for supplying transmission fluid to a transmission. The mechanical pump may be powered by the engine. However, a parallel hybrid vehicle may operate in an electric vehicle mode in which the fuel engine is turned off. With the fuel engine turned off, the mechanical pump is unable to supply pressure for the transmission fluid. Thus, it may be necessary to provide an alternate system and method for pressurizing the transmission fluid. One possibility is to operate an auxiliary pump powered by the vehicle's electric bus.

However, in transitioning from a fuel engine mode to an electric vehicle mode, pressure may be lost in the transmission fluid system due to the stoppage of the mechanical pump. Line pressure fluctuations such as this can dramatically affect rotor speed of the electric pump. Low cost sensors or sensorless motors have difficulty recovering from these speed fluctuations, especially if there is a deadhead condition in the electric pump fluid sub-system.

Accordingly, it is desirable to provide a system and method for controlling flow of transmission fluid in a vehicle that will maintain pressure in the transmission fluid system during a transition from fuel engine mode to electric vehicle mode and continuing during electric driving. Additionally, it is desirable to provide a system and method for preventing a deadhead condition in the electric pump fluid sub-fluid system.

Additionally, in both traditional vehicles and parallel hybrid vehicles in fuel engine mode, the transmission fluid system requires a normal amount of pressurization and flow under typical conditions. However, there are a small number of situations in which an increased pressurization and flow are required.

These situations typically occur when the engine speed is low but the driver torque request is high, such as shifting from park to drive or reverse, climbing a hill, or recovering from a stall. Accordingly, it is necessary that the capacity of the mechanical pump be sufficient to cover the increased pressurization situations. However, this is inefficient because the increased pump capacity is only needed for a small fraction of time, while a decreased pump capacity would be sufficient for most of the time the engine is operating.

Accordingly, it is desirable to provide a system and method for controlling flow of transmission fluid in a vehicle that will allow for a smaller capacity mechanical pump while still providing the increased capacity when necessary.

### SUMMARY

In one exemplary embodiment, a system for controlling flow of transmission fluid in a vehicle having a transmission with a transmission fluid intake and a transmission fluid discharge may include a first pump, a second pump, a first check valve, a second check valve, and a fluid line. The first pump may include a first pump intake in fluid communication with the transmission fluid discharge and a first pump discharge in fluid communication with the transmission fluid intake. The second pump may include a second pump intake and a second pump discharge. The first check valve may include a first check valve input in fluid communication with the second pump discharge and a first check valve output in fluid communication with the transmission fluid intake. The second check valve may include a second check valve input in fluid communication with the transmission fluid discharge and a second check valve output in fluid communication with the second pump intake. The fluid line may include a first end in fluid communication with the second pump discharge and a second end in fluid communication with the second check valve input.

In another exemplary embodiment of the system the fluid line may further include a flow regulator structure to regulate fluid flow in the fluid line.

In another exemplary embodiment of the system the flow regulator may be an orifice having an orifice diameter smaller than a diameter of the fluid line.

In another exemplary embodiment of the system the flow regulator may be a blowoff valve.

In another exemplary embodiment of the system the flow regulator may be a pressure regulating valve.

In another exemplary embodiment the system may include a controller and a detector configured to detect a first information of the vehicle. The controller may be configured to, in response to the first information satisfying a first predetermined condition and while the first pump is activated, activate the second pump.

In another exemplary embodiment of the system the first information may include a pedal position and a vehicle speed, and the first predetermined condition may be whether the pedal position is less than a pedal threshold and the vehicle speed is less than a vehicle speed threshold.

In another exemplary embodiment of the system the first information may include an engine speed and a driver torque request and the first predetermined condition may be whether the engine speed is less than an engine speed threshold and the driver torque request is greater than a torque threshold.

In another exemplary embodiment of the system the detector may be configured to detect a second information of the vehicle. The controller may be configured to, in response to the second information satisfying a second predetermined condition, operate the second pump at a speed sufficient to supply transmission fluid to the transmission.

In another exemplary embodiment of the system the second information may include an engine speed and the second predetermined condition may be whether the engine speed is less than an engine speed threshold.

In another exemplary embodiment the system may include a controller and a detector configured to detect a first information of the vehicle. The controller may be configured to, in response to the first information satisfying a first predetermined condition and while the second pump is activated, deactivate the second pump.

In another exemplary embodiment of the system, the first information may include a pedal position and a vehicle speed, and the first predetermined condition may include whether the pedal position is greater than or equal to a pedal threshold and the vehicle speed is greater than or equal to a vehicle speed threshold.

In one exemplary embodiment, a method for controlling flow of transmission fluid in a vehicle having a transmission, a first pump in fluid communication with the transmission, and a second pump in fluid communication with the transmission may include detecting a first information of the vehicle and, in response to the first information satisfying a first predetermined condition and while the first pump is activated, activating the second pump.

In another exemplary embodiment, the method may include detecting a second information of the vehicle and, in response to the second information satisfying a second predetermined condition, operating the second pump at a speed sufficient to supply transmission fluid to the transmission.

In another exemplary embodiment, the method may include detecting a third information of the vehicle and, in response to the third information satisfying a third predetermined condition, deactivating the second pump.

In another exemplary embodiment of the method, the first information may include a pedal position and a vehicle speed, and the first predetermined condition may include whether the pedal position is less than a pedal threshold and the vehicle speed is less than a vehicle speed threshold.

In another exemplary embodiment of the method the second information may include an engine speed and the second predetermined condition may be whether the engine speed is less than an engine speed threshold.

In other exemplary embodiment of the method the third information may include a pedal position and a vehicle speed, and the third predetermined condition may be whether the pedal position is greater than or equal to a pedal threshold and the vehicle speed is greater than or equal to a vehicle speed threshold.

In other exemplary embodiment of the method, the first information may include an engine speed and a driver torque request, and the first predetermined condition may be whether the engine speed is less than an engine speed threshold and the torque is greater than a torque threshold.

In one exemplary embodiment, a method for controlling flow of transmission fluid in a vehicle having a transmission, a first pump in fluid communication with the transmission, and a second pump in fluid communication with the transmission may include detecting a first information of the vehicle and, in response to the first information satisfying a first predetermined condition and while the second pump is activated, deactivating the second pump.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of an exemplary embodiment of a system for controlling flow of a transmission fluid;

FIG. 2 is a schematic diagram of an exemplary embodiment of a system for controlling flow of a transmission fluid;

FIG. 3 is a schematic diagram of an exemplary embodiment of a system for controlling flow of a transmission fluid;

FIG. 4 is a schematic diagram of an exemplary embodiment of a system for controlling flow of a transmission fluid;

FIG. 5 is a schematic diagram of an exemplary embodiment of a system for controlling flow of a transmission fluid;

FIG. 6 is a schematic diagram of an exemplary embodiment of a system for controlling flow of a transmission fluid;

FIG. 7 is a flow chart of an exemplary embodiment of a method for controlling flow of a transmission fluid; and

FIG. 8 is a schematic diagram of an exemplary embodiment of a system for controlling flow of a transmission fluid.

### DETAILED DESCRIPTION

The following description is merely exemplary in nature and is not intended to limit the present disclosure, its application or uses.

It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

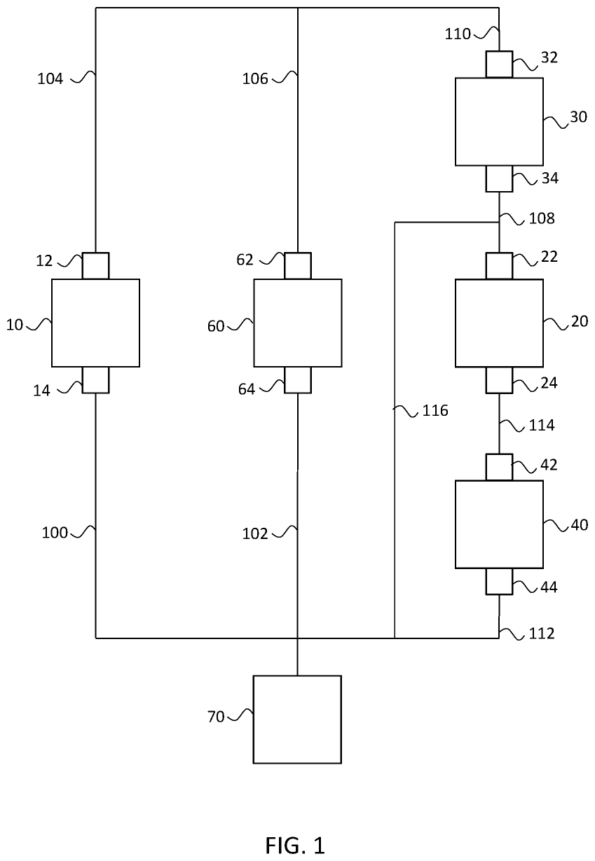

In accordance with an exemplary embodiment, FIG. 1 shows a system for controlling transmission fluid in a vehicle having a transmission 60. Transmission 60 may include transmission fluid intake 62 through which transmission fluid is supplied to transmission 60 and transmission fluid discharge 64 through which transmission fluid leaves transmission 60.

The system may include a first pump 10 having a first pump intake 14 and a first pump discharge 12. First pump intake 14 may be in fluid communication with transmission fluid discharge 64. For example, first pump intake 14 may be connected to transmission fluid discharge 64 via fluid line 100 and fluid line 102. First pump discharge 12 may be in fluid communication with transmission fluid intake 62. For example, first pump discharge 12 may be connected to transmission fluid intake 62 via fluid line 104 and fluid line 106. First pump 10 may be powered by a fuel engine (not shown) of the vehicle.

The system may further include a second pump 20 having a second pump intake 24 and a second pump discharge 22. Second pump 20 may be powered by an electrical bus (not shown) of the vehicle.

The system may further include a first check valve 30 having a first check valve input 34 and a first check valve output 32. First check valve input 34 may be in fluid communication with second pump discharge 22. For example, first check valve input 34 may be connected to second pump discharge 22 via fluid line 108. First check valve output 32 may be in fluid communication with transmission fluid intake 62. For example, first check valve output 32 may be connected to transmission fluid intake via fluid line 110 and fluid line 106. First check valve 30 may be configured to allow one way flow from first check valve input 34 through first check valve output 32. First check valve 30 may be a ball check valve or any other suitable type of check valve, including, but not limited to, a diaphragm check valve, a tilting disk check valve, a clapper valve, a stop-check valve, a lift-check valve, an in-line check valve, a duckbill valve, a piston check valve, a wafer check valve, or a ball-and-cone check valve.

The system may further include second check valve 40 having a second check valve input 44 and a second check valve output 42. Second check valve input 44 may be in fluid communication with transmission fluid discharge 64. For example, second check valve input 44 may be connected to transmission fluid discharge 64 via fluid line 112 and fluid line 102. Second check valve output 42 may be in fluid communication with second pump intake 24. For example, second check valve output 42 may be connected to second pump intake 24 via fluid line 114. Second check valve 40 may be configured to allow one way flow from second check valve input 44 through second check valve output 42. Second check valve 40 may be a ball check valve or any other suitable type of check valve, including but not limited to a diaphragm check valve, a tilting disk check valve, a clapper valve, a stop-check valve, a lift-check valve, an in-line check valve, a duckbill valve, a piston check valve, a wafer check valve, or a ball-and-cone check valve.

The system may further include a fluid line 116. A first end of the fluid line 116 may be in fluid communication with the second pump discharge 22. For example, the first end of the fluid line 116 may be connected to fluid line 108. A second end of the fluid line 116 may be in fluid communication with the second check valve input 44. For example, the second end of the fluid line 116 may be connected to fluid line 112.

The system may further include a sump 70.

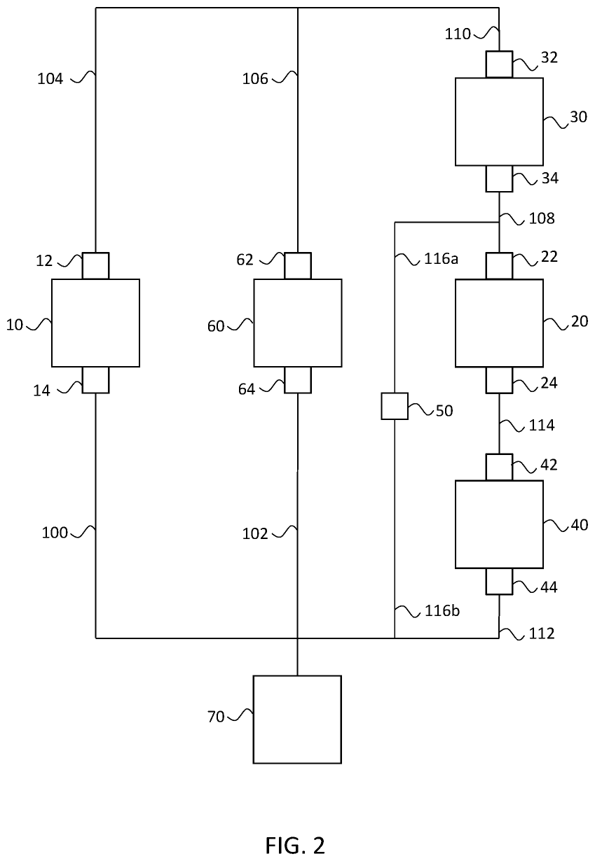

FIG. 2 shows an exemplary embodiment in which the fluid line 116 may further include a flow regulator 50. In FIG. 2, fluid line 116 is shown in two segments, segment 116a and segment 116b. Flow regulator 50 may be structured to regulate fluid flow through fluid line 116. Flow regulator 50 may be an orifice having an orifice diameter smaller than a diameter of fluid line 116. For example, the orifice diameter may be 0.5 mm and the diameter of fluid line 116 may be 8 mm. Alternatively, flow regulator 50 may be a blowoff valve or a pressure regulating valve. Alternatively, flow regulator 50 may be a check valve structured to allow one-way flow once a certain pressure is reached. Overall, flow regulator 50 releases fluid from segment 116a while second pump 20 is activated without losing too much pressure. For example, in an exemplary embodiment, flow regulator 50 may restrict the flow through fluid line 116 to 20% or less than what the flow would be without flow regulator 50.

The paragraphs above frequently describe a first structure as “in fluid communication” with a second structure. This is intended to mean that fluid is capable of flowing between the first structure and second structure. In FIG. 1 and FIG. 2, the fluid communication is illustrated via various fluid lines. However, it will be understood that the arrangement of fluid lines in FIG. 1 and FIG. 2 is not the only way for the various components to be in fluid communication, and there may be variations in the arrangements and connections of specific fluid lines.

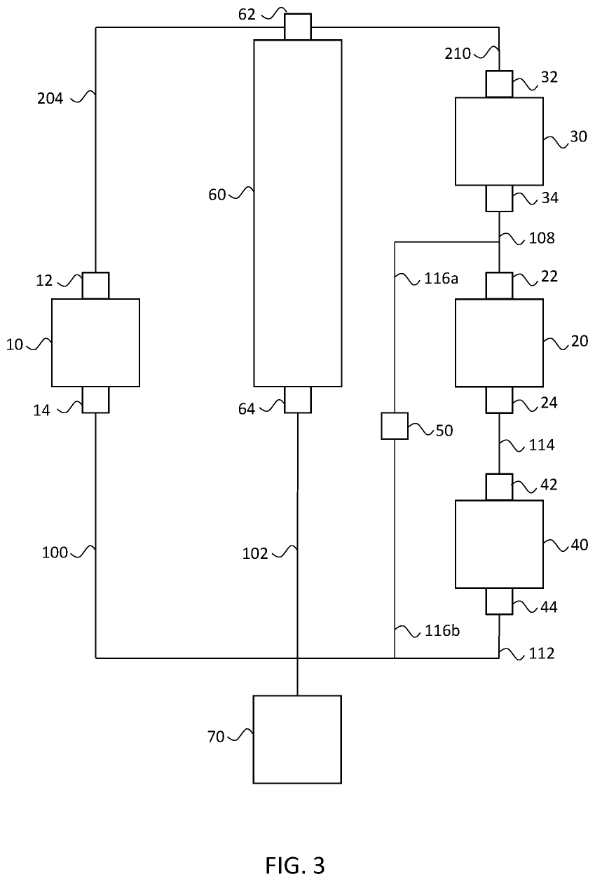

For example, FIG. 3 shows an exemplary embodiment in which first pump discharge 12 may be directly connected to transmission fluid intake 62 via fluid line 204, and first check valve output 32 may be directly connected to transmission fluid intake 62 via fluid line 210. Thus, while FIG. 1, FIG. 2, and FIG. 3 each show first pump discharge 12 and first check valve output 32 in fluid communication with transmission fluid intake 62, the arrangement of the specific fluid lines is different. Therefore, it will be understood that the specific configuration of fluid lines may be modified while still maintaining fluid communication between components.

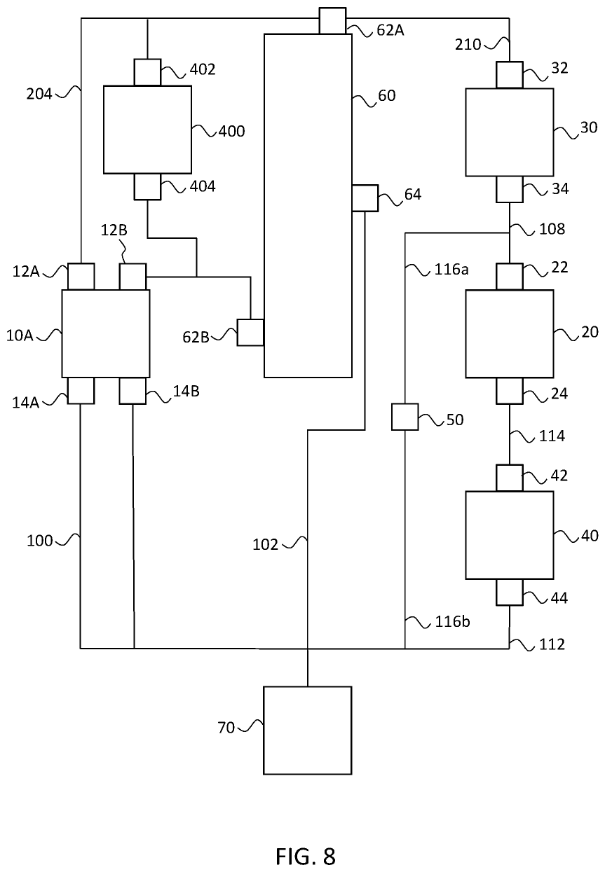

FIG. 8 shows another exemplary embodiment of a system for controlling flow of transmission fluid. The embodiment of FIG. 8 is similar to the embodiment of FIG. 3 except for the differences noted below. In the embodiment of FIG. 8, the first pump may be a binary first pump 10A. Binary first pump 10A may include primary first pump discharge 12A, secondary first pump discharge 12B, primary first pump intake 14A, and secondary first pump intake 14B. Primary first pump discharge 12A may be in fluid communication with primary transmission fluid intake 62A. Secondary first pump discharge 12B may be in fluid communication with secondary transmission fluid intake 62B. Primary first pump intake 14A and secondary first pump intake 14B may be in fluid communication with transmission fluid discharge 64 and sump 70. The embodiment of FIG. 8 may also include third check valve 400. Third check valve 400 may have third check valve output 402 in fluid communication with primary transmission fluid intake 62A and primary first pump discharge 12A. Third check valve 400 may also have third check valve input 404 in fluid communication secondary transmission fluid intake 62B and secondary first pump discharge 12B.

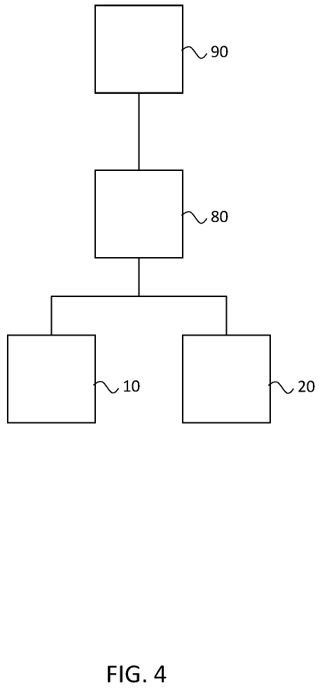

FIG. 4 shows an exemplary embodiment of a system for controlling operation of first pump 10 and second pump 20. For example, the system may include a controller 80 and a detector 90. Detector 90 may be configured to detect a first information of the vehicle. Controller 80 may be configured to, in response to the first information satisfying a first predetermined condition and while first pump 10 is activated, activate second pump 20.

For example, in a parallel hybrid vehicle, the first information may be a pedal position of an accelerator pedal and a vehicle speed. The first predetermined condition may be whether the pedal position is less than a pedal threshold and whether the vehicle speed is less than a vehicle speed threshold. In an exemplary embodiment, the pedal threshold may be 20% and the vehicle speed threshold may be 30 km/h. However, it will be understood that the pedal threshold and the vehicle speed threshold are not limited to these values and may be adjusted depending on the specifications of a particular vehicle. In other words, controller 80 is using the first information and the first predetermined condition to determine whether the hybrid vehicle is about to transition from a fuel engine mode to an electric vehicle mode. If the first predetermined condition is satisfied and second pump 20 is activated while first pump 10 is still activated, this allows for second pump 20 to build pressure before the transition to electric vehicle mode is completed. This eliminates a deadhead conditions and reduces line pressure fluctuations when transitioning to electric vehicle mode.

It will be understood that flow regulator 50 and first check valve 30 are configured such that, in a state that the first predetermined condition is satisfied and second pump 20 is activated, the pressure generated by second pump 20 is insufficient to produce flow through first check valve 30. For example, if flow regulator 50 is an orifice, a diameter of the orifice is selected such that a fluid pressure in fluid line 108 does not exceed a pressure threshold of first check valve 30. Alternatively, if flow regulator 50 is a blowoff valve, pressure regulating valve, or check valve, a pressure threshold of flow regulator 50 will be lower than a pressure threshold of first check valve 30.

Detector 90 may be further configured to detect a second information of the vehicle. Controller 80 may be configured to, in response to the second information satisfying a second predetermined condition, operate second pump 20 at a speed sufficient to supply transmission fluid to the transmission.

For example, in a parallel hybrid vehicle, the second information may be a fuel engine speed, and the second predetermined condition may be whether the fuel engine speed is less than an engine speed threshold. In an exemplary embodiment, the fuel engine speed threshold may be 2000 rpm.

However, it will be understood that the engine speed threshold is not limited to this value and may be adjusted depending on the specifications of a particular vehicle. In other words, controller 80 is using the second information and the second predetermined condition to determine when the transition from fuel engine mode to electric vehicle mode occurs. If the second predetermined condition is satisfied and second pump 20 is operated at a speed sufficient to supply transmission fluid to transmission 60, this allows for the vehicle to transition to electric vehicle mode while maintaining sufficient pressure of transmission fluid in transmission 60, avoiding fluctuations in transmission line pressure and allowing a smoother transition to electric vehicle mode.

It will be understood that flow regulator 50 and first check valve 30 are configured such that, in a state that the second predetermined condition is satisfied, the pressure generated by second pump 20 is sufficient to produce flow through first check valve 30. For example, once the second predetermined condition is satisfied, second pump 20 will be operated at a speed such that a fluid pressure in fluid line 108 will exceed a pressure threshold of first check valve 30. Alternatively, if flow regulator 50 is blowoff valve, pressure regulating valve, or check valve, a pressure threshold of flow regulator 50 will be lower than a pressure threshold of first check valve 30.

Detector 90 may be configured to detect a third information of the vehicle. Controller 80 may be configured to, in response to the third information satisfying a third predetermined condition and while second pump 20 is activated, deactivate second pump 20.

For example, in a parallel hybrid vehicle the third information may be a pedal position and a vehicle speed, and the third predetermined condition may be whether the pedal position is greater than or equal to a second pedal threshold and whether the vehicle speed is greater than or equal to a second vehicle speed threshold. In an exemplary embodiment, the second pedal threshold may be 20% and the second engine speed threshold may be 2000 rpm.

However, it will be understood that the second pedal threshold and the second engine speed threshold are not limited to these values and may be adjusted depending on the specifications of a particular vehicle. In other words, controller 80 is using the third information and the third predetermined condition to determine whether the vehicle is transitioning from electric vehicle mode to fuel engine mode. If the third predetermined condition is satisfied and second pump 20 is deactivated, this allows the vehicle to conserve electrical energy, as first pump 10 will be activated in fuel engine mode and second pump 20 will no longer be necessary.

In another exemplary embodiment, the first information may be a fuel engine speed of the vehicle and a driver torque request. The first predetermined condition may be whether the fuel engine speed is less than a third fuel engine speed threshold and driver torque request is greater than a torque threshold. For example, the third fuel engine speed threshold may be 2000 rpm and the torque threshold may be 70% of engine torque. However, it will be understood that the third engine speed threshold and the torque threshold are not limited to these values and may be adjusted depending on the specifications of a particular vehicle. This particular application of information and predetermined condition is useful in both conventional and hybrid vehicles. For example, there are some situations while driving in which the fuel engine speed will be low and the driver torque request will be high, such as shifting from park into drive or reverse, climbing a steep hill, or recovering from a stall. In these situations, a greater strain is placed on transmission 60 than in normal driving, and it may be helpful to have additional transmission fluid pressure and flow. Thus, if controller 80 activates second pump 20 while this predetermined condition is satisfied and first pump 10 is activated, second pump 20 will supplement first pump 10 to supply additional transmission fluid pressure and flow, thereby reducing strain on transmission 60. Therefore, a smaller capacity pump may be used as first pump 10, while still providing sufficient capacity to account for situations requiring increased pressurization and flow in the transmission fluid line.

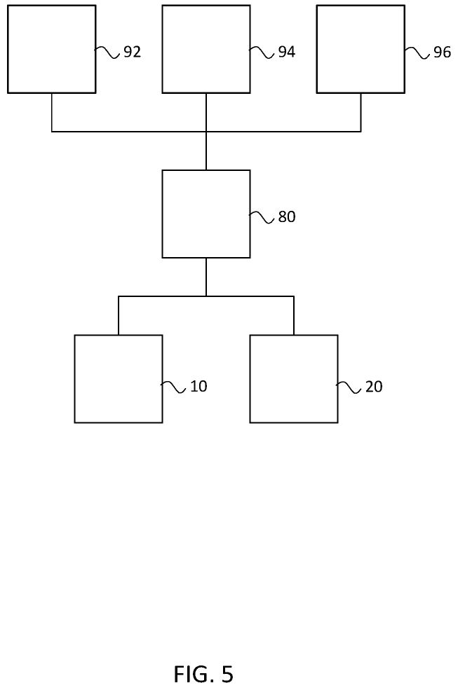

FIG. 4 schematically shows detector 90 as a single structure. However, it will be understood that detector 90 is not limited to this structure. For example, as seen in FIG. 5, the detector may be configured as a plurality of separate detectors 92, 94, 96. In an exemplary embodiment, detector 92 may be a sensor configured to detect a position of an accelerator pedal, detector 94 may be a speedometer or a global positioning system (GPS) module configured to calculate vehicle speed, and detector 96 may be a sensor configured to detect an engine speed.

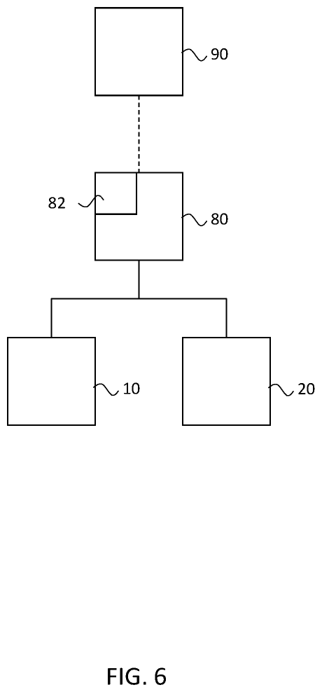

FIG. 4 also schematically shows detector 90 as being a separate structure from controller 80. However, it will be understood that detector 90 and controller 80 are not limited to this structure. For example, as seen in FIG. 6, detector 82 may be configured as a subsystem or submodule of controller 80, either alone or in combination with a separate detector 90 (the broken line in FIG. 6 indicates the optional presence of detector 90). For example, detector 82 may be a submodule configured to calculate torque requirements of the vehicle.

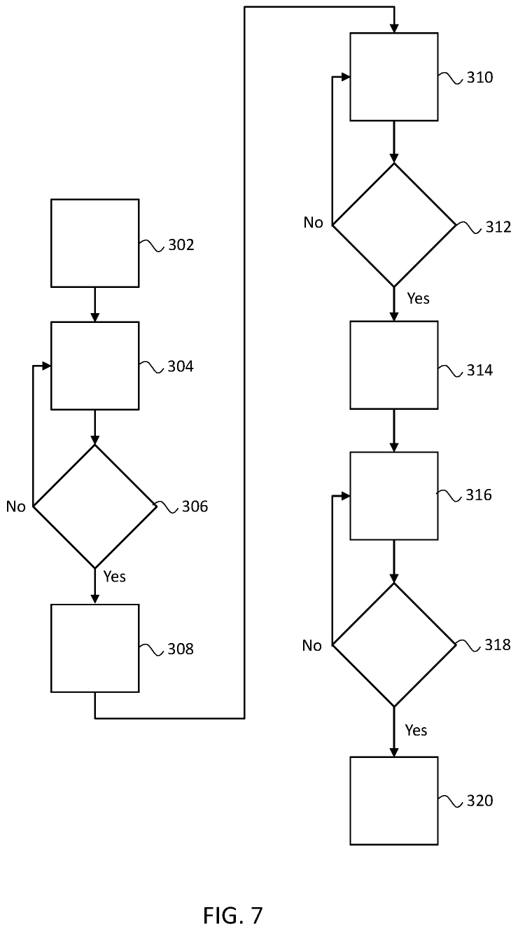

FIG. 7 illustrates an exemplary embodiment of a method for controlling flow of transmission fluid in a vehicle having a transmission, a first pump in fluid communication with the transmission, and a second pump in fluid communication with the transmission. In block 302, the first pump is activated. In block 304, a first information of the vehicle is detected. In block 306, it is determined whether the first information satisfies a first predetermined condition. If the first predetermined condition is not satisfied (“No” at block 306), then the method returns to block 304. If the first predetermined condition is satisfied (“Yes” at block 306), then the method continues to block 308. In block 308, the second pump is activated. In block 310, a second information of the vehicle is detected. In block 312, it is determined whether the second information satisfies a second predetermined condition. If the second predetermined condition is not satisfied (“No” at block 312), then the method returns to block 310. If the second predetermined condition is satisfied (“Yes” at block 312), then the method proceeds to block 314. In block 314, the second pump is operated at a speed sufficient to supply transmission fluid to the transmission. At block 316, a third information of the vehicle is detected. In block 318 it is determined whether the third information satisfies a third predetermined condition. If the third predetermined condition is not satisfied (“No” at block 318), then the method returns to block 316. If the third predetermined condition is satisfied (“Yes” at block 318), then the method proceeds to block 320. In block 320, the second pump is deactivated. Exemplary embodiments of the first information, second information, third information, first predetermined condition, second predetermined condition, and third predetermined condition are discussed above.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A system for controlling flow of transmission fluid in a vehicle having a transmission with a transmission fluid intake and a transmission fluid discharge, the system comprising:
a first pump comprising:
a first pump intake in fluid communication with the transmission fluid discharge; and
a first pump discharge in fluid communication with the transmission fluid intake;
a second pump comprising a second pump intake and a second pump discharge;
a first check valve comprising:
a first check valve input in fluid communication with the second pump discharge; and
a first check valve output in fluid communication with the transmission fluid intake;
a second check valve comprising:
a second check valve input in fluid communication with the transmission fluid discharge; and
a second check valve output in fluid communication with the second pump intake; and
a fluid line comprising:
a first end in fluid communication with the second pump discharge; and
a second end in fluid communication with the second check valve input.

2. The system of claim 1, wherein the fluid line further comprises a flow regulator structured to regulate fluid flow in the fluid line.

3. The system of claim 2, wherein the flow regulator is an orifice having an orifice diameter smaller than a diameter of the fluid line.

4. The system of claim 2, wherein the flow regulator is a blowoff valve.

5. The system of claim 2, wherein the flow regulator is a pressure regulating valve.

6. The system of claim 1, further comprising:
a controller; and
a detector configured to detect a first information of the vehicle;
wherein the controller is configured to, in response to the first information satisfying a first predetermined condition and while the first pump is activated, activate the second pump.

7. The system of claim 6, wherein
the first information comprises a pedal position and a vehicle speed; and
the first predetermined condition is whether the pedal position is less than a pedal threshold and the vehicle speed is less than a vehicle speed threshold.

8. The system of claim 7, wherein
the detector is configured to detect a second information of the vehicle; and
the controller is configured to, in response to the second information satisfying a second predetermined condition, operate the second pump at a speed sufficient to supply transmission fluid to the transmission.

9. The system of claim 8, wherein
the second information comprises an engine speed; and
the second predetermined condition is whether the engine speed is less than an engine speed threshold.

10. The system of claim 6, wherein
the first information comprises an engine speed and a driver torque request; and
the first predetermined condition is whether the engine speed is less than an engine speed threshold and the torque is greater than a torque threshold.

11. The system of claim 1, further comprising:
a controller; and
a detector configured to detect a first information of the vehicle;
wherein the controller is configured to, in response to the first information satisfying a first predetermined condition and while the second pump is activated, deactivate the second pump.

12. The system of claim 11, wherein
the first information comprises a pedal position and a vehicle speed; and
the first predetermined condition is whether the pedal position is greater than or equal to a pedal threshold and the vehicle speed is greater than or equal to a vehicle speed threshold.

13. A method for controlling flow of transmission fluid in a vehicle having a transmission, a first pump in fluid communication with the transmission, and a second pump in fluid communication with the transmission, the method comprising:
detecting a first information of the vehicle; and
in response to the first information satisfying a first predetermined condition and while the first pump is activated, activating the second pump.

14. The method of claim 13, further comprising:
detecting a second information of the vehicle; and
in response to the second information satisfying a second predetermined condition, operating the second pump at a speed sufficient to supply transmission fluid to the transmission.

15. The method of claim 14, further comprising:
detecting a third information of the vehicle; and
in response to the third information satisfying a third predetermined condition, deactivating the second pump.

16. The method of claim 13, wherein
the first information comprises a pedal position and a vehicle speed; and
the first predetermined condition is whether the pedal position is less than a pedal threshold and the vehicle speed is less than a vehicle speed threshold.

17. The method of claim 14, wherein
the second information comprises an engine speed; and
the second predetermined condition is whether the engine speed is less than an engine speed threshold.

18. The method of claim 15, wherein
the third information comprises a pedal position and a vehicle speed; and
the third predetermined condition is whether the pedal position is greater than or equal to a pedal threshold and the vehicle speed is greater than or equal to a vehicle speed threshold.

19. The method of claim 13, wherein
the first information comprises an engine speed and a driver torque request; and
the first predetermined condition is whether the engine speed is less than an engine speed threshold and the torque is greater than a torque threshold.

20. A method for controlling flow of transmission fluid in a vehicle having a transmission, a first pump in fluid communication with the transmission, and a second pump in fluid communication with the transmission, the method comprising:
activating the first pump and the second pump;
detecting a first information of the vehicle; and
in response to the first information satisfying a first predetermined condition and while the second pump is activated, deactivating the second pump
